(19) United States
(12) Patent Application Publication
(10) Pub. No.: US 2024/0040294 A1
(43) Pub. Date: Feb. 1, 2024

(54) Integrated housing and passive cooling for an acoustic camera

(71) Applicant: Sorama Holding B.V., Eindhoven (NL)

(72) Inventors: Rick Scholte, Eindhoven (NL); Ivo Jansen, Eindhoven (NL)

(21) Appl. No.: 18/266,066

(22) PCT Filed: Dec. 16, 2021
(86) PCT No.: PCT/EP2021/086138

§ 371 Date: Jun. 8, 2023

Related U.S. Application Data
(60) Provisional application No. 63/127,845, filed on Dec. 18, 2020.

(51) Int. Cl. H04R 1/08; H04R 9/02; H04N 23/51; H04N 23/63

(52) U.S. Cl. CPC H04R 1/08; H04R 9/022; H04N 23/51; H04N 23/632; H04R 2201/40; H04R 2499/11

(57) ABSTRACT

Improved passive heat sinking of acoustic cameras having a microphone array and onboard processor is provided. The onboard processor is heat sunk using a heat sink member within a sealed enclosure to conduct heat to a heat dissipation surface of the enclosure. Preferably the heat sink member is mostly a spring member having the dual functions of providing mechanical force to ensure good thermal contact with the onboard processor and providing heat conduction to the heat dissipation surface. A single enclosure can enclose both the onboard processor and the microphone array. Alternatively, the enclosure can have two parts, a first part enclosing the microphone array, and a second part enclosing the onboard processor.

### FIELD OF THE INVENTION

This invention relates to heat sinking of acoustic cameras.

### BACKGROUND

Over the past decades, noise pollution has become an increasing problem. To reduce noise emissions, local governments and factories are installing acoustic noise sensors to monitor and create insights into the noise sources. The acoustic camera is capable of fulfilling that need in environmental as well as industrial applications. An acoustic camera may include an array of microphones and may or may not be combined with a visual image capturing device or camera. Fixed acoustic cameras that may be installed for acoustic imaging with far-field beamforming (BF) applications as well as environmental sound level monitoring are commercially available.

The acoustic camera is increasingly used as a multi-functional smart IOT (internet of things), handheld or mobile device. For example, a 16 by 16 centimeter 64-channel MEMS microphone array can be installed in a light pole above a traffic intersection. A signal processing and compute unit can be integrated within the same small form factor apparatus, as well as a power supply unit and connectivity. Due to privacy and data protection laws the raw data is preferably processed as near to the sensor array as possible, in order to minimize the risk of data theft and other risks to data protection and privacy. Typically, only processed, secure and anonymized data may be communicated outside of the apparatus. Therefore, highly complex and/or computationally intense processes are performed on the onboard processor. Another reason for near the sensor array, or onboard, computing are data bandwidth limitations.

Significant onboard processing power is required for performing acoustic beamforming, spectral analysis, acoustic anomaly detection, acoustic event localization, signal classification (by means of artificial intelligence acoustic modelling), or other computationally intense operations. Currently, this may be processed by central as well as graphical processing units (CPU and GPU), ASICs or FPGAs. This type of onboard processing in a small form factor device requires a significant amount of power to be dissipated as heat to the environment. If this is not executed correctly it will cause the compute unit to stop functioning, potentially resulting in complete loss of function of the apparatus, which most probably results in data loss.

In standard applications a metal cooling element with ribs to maximize the area that is in contact with the environment (often this is air) is used for cooling. An active cooling solution is often required for high performance onboard computers, which may contain water cooling or ventilators. In case of the acoustic camera function the use of ventilators or pumps that may produce noise is prohibited, or should at the very least be limited. Therefore, a passive solution is preferred when edge computing is involved. Furthermore, active cooling solutions limit the continuity or the monitoring function in the field, while the acoustic monitoring function is often required to function for multiple years continuously. This introduces extra costs and need for maintenance. Meaning there is a significant and continuous gain if passive cooling can be established.

Accordingly, it would be an advance in the art to provide improved passive heat sinking for acoustic cameras having substantial onboard processing.

### SUMMARY

In this work, an apparatus is provided that includes a microphone array into part of the same housing as the advanced processing unit or onboard computer. The housing can be limited in size and weight due to the constraints set by the industrial or city space applications and the way it needs to be mounted to the infrastructure. Lightweight, ingress protection, ease of installation and robustness are key properties that need to be optimized in order for the apparatus to be acceptable in that application space.

Therefore, in case of proper heat dissipation, while taking into account the described key properties, the onboard computer can be connected with a heatsink that is an integral part to the outer design of the apparatus. Since the onboard computer is located inside the housing (or volume), a solution is found to transfer the heat efficiently from the compute unit, through a metal heat spreader and part of the inner structure to the outer housing. In this case the metal heat dissipation part has a large effective area as an integral part of the outer housing of the product (see examples below). The solution may or may not contain ribs to maximize the effective area for heat dissipation. However, visual and functional design considerations may limit that option. For example, dusty environments may clog the channels in between the ribs. Also, the ingress protection capabilities are improved with the closed outer design of the metal casing.

Additionally, the internal structure of the metal heat dissipation part of the apparatus may be constructed such that the inner structure acts as a mechanical spring. This is an important feature in the robustness of the apparatus as well as the heat spreading capabilities. The internal (leaf) spring puts a small pressure of the heat spreader component that is in direct contact with the high power components on the outside of the computer chip. If the tension is not correctly applied over the whole area, parts of the chip may fail due to overheating.

### BRIEF DESCRIPTION OF THE DRAWINGS

FIG. 1A schematically shows a first exemplary embodiment of the invention.

FIG. 1B schematically shows a second exemplary embodiment of the invention.

FIGS. 2A-C show a detailed example of the embodiment of FIG. 1B.

FIGS. 3A-D are several simplified views showing the heat sink member of the example of FIGS. 2A-C.

FIG. 4A schematically shows a third exemplary embodiment of the invention.

FIG. 4B schematically shows a fourth exemplary embodiment of the invention.

FIGS. 5A-D are several simplified views showing an exemplary second part of the enclosure as on FIG. 4B.

FIG. 5E is a side view showing a hand-held acoustic camera having a two-part enclosure as on FIG. 4B, where the back side of the enclosure is attached to an auxiliary unit.

### DETAILED DESCRIPTION

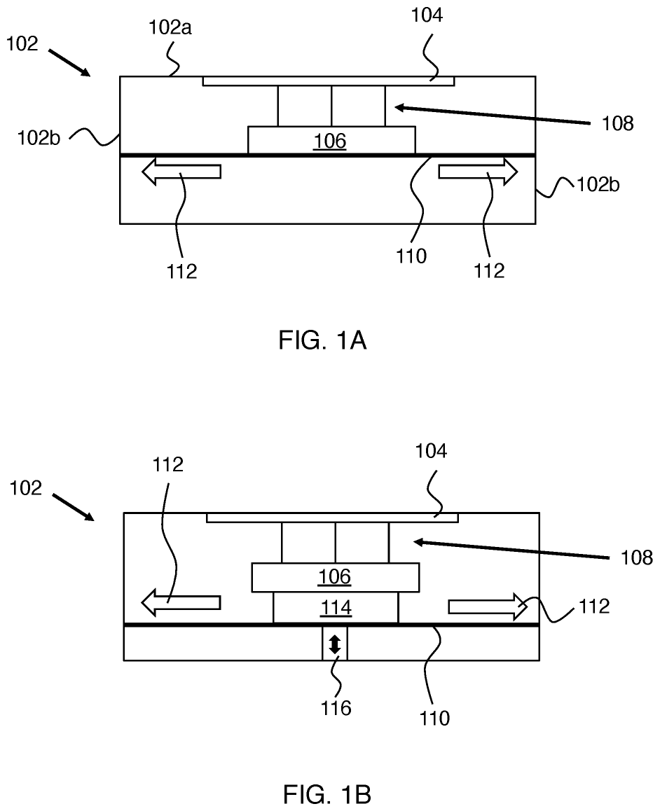

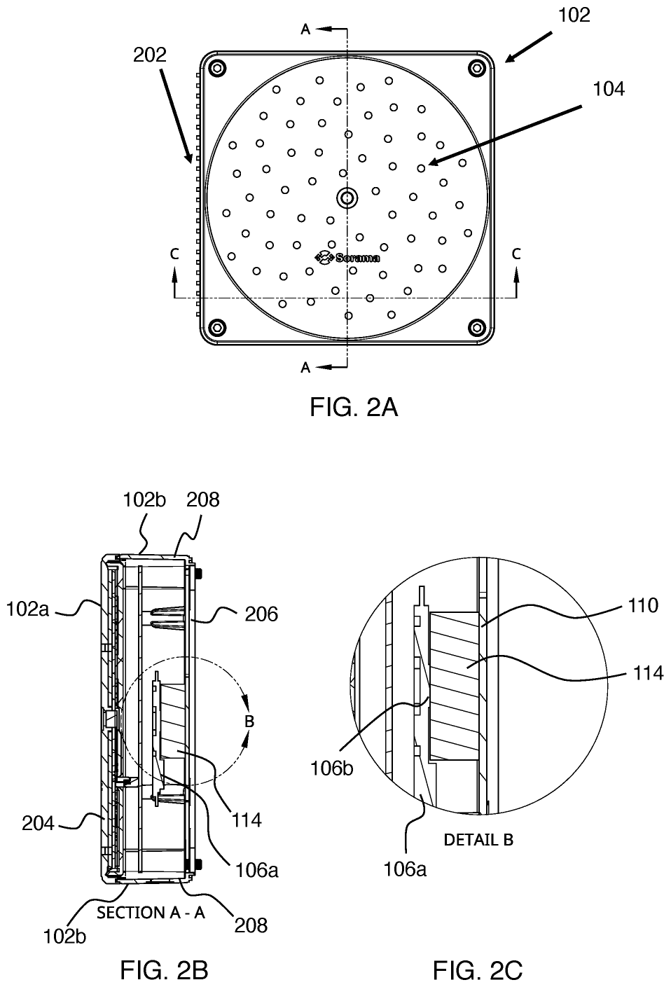

FIG. 1A schematically shows a first exemplary embodiment of the invention. This example is an acoustic camera including an enclosure 102 configured to enclose a volume; an acoustic microphone array 104 disposed at a first surface 102a of the enclosure and facing away from the volume; an onboard processor 106 disposed within the volume and electrically connected (via connections schematically shown as 108) to the acoustic microphone array 104; and a heat sink member 110 in thermal contact with the onboard processor 106. The heat sink member 110 is configured to conduct heat from the onboard processor 106 to a heat dissipation surface 102b of the enclosure distinct from the first surface 102a. Here this heat conduction is schematically shown with block arrows 112.

FIG. 1B schematically shows a second exemplary embodiment of the invention, including several optional features.

A first optional feature is a thermal transfer block 114 configured to at least partially fill a space between the heat sink member 110 and the onboard processor 106.

A second optional feature is the use of spring tension to improve thermal contact between the heat sink member and the onboard processor. This is shown on FIG. 1B as the apparatus including a spring member 116 configured to provide a mechanical force (solid black block arrow) tending to keep the heat sink member 110 in thermal contact with the onboard processor 106 (via thermal transfer block 114).

However, it is often preferable for the heat sink member 110 to itself be configured as a mechanical spring that supplies the required contact force for good thermal contact. In this case, there is no separate spring element 116 as in the example of FIG. 1B, and instead the spring member (which is part of the heat sink member) is configured to make thermal contact to the onboard processor to conduct heat from the onboard processor to the heat dissipation surface. In this case, 110 as on FIG. 1A or FIG. 1B is both the heat sink member and the spring member.

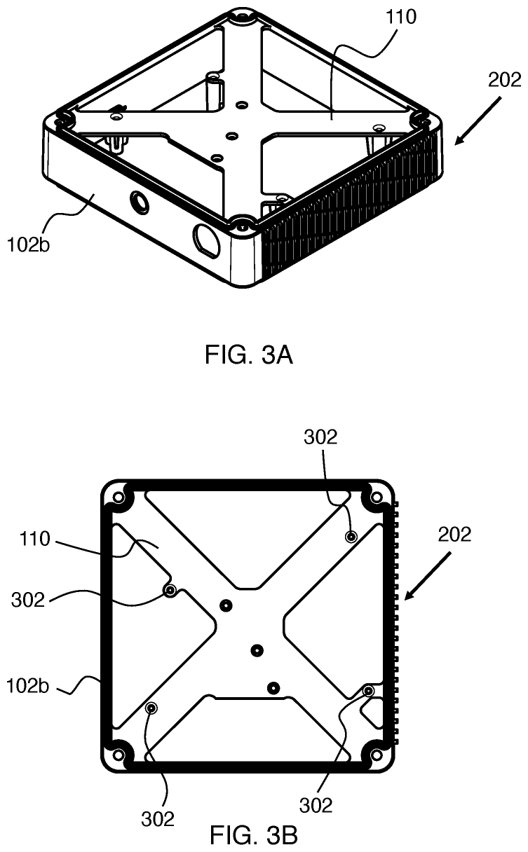

FIGS. 2A-C show a detailed example of the embodiment of FIG. 1B, including some additional optional features. The acoustic camera can include one or more heat sink fins 202 (on FIG. 2A) disposed on the heat dissipation surface 102b. The enclosure 102 can be square or rectangular, thereby having four corners. The enclosure can include a front plate 204, a back plate 206 opposite to the front plate 204, and a side wall 208, where the side wall 208 connects the front plate 204 to the back plate 206 to thereby enclose the volume (see FIG. 2B). The onboard processor 106 can be configured as system on module 106a including at least one integrated circuit die 106b, where the die 106b makes direct contact to thermal transfer block 114, as shown on FIG. 2C. Here the die 106b is not a bare chip, but is packaged in a package that provides a good thermal contact surface for heat transfer, as is known in the art. In this example, the heat dissipation surface 102b of the enclosure 102 is on the side wall 208.

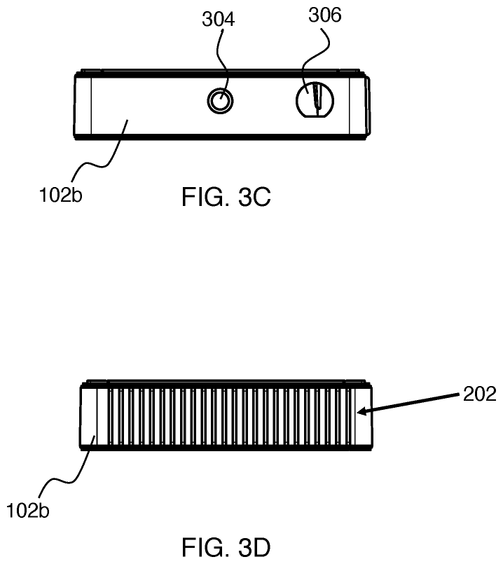

FIGS. 3A-D are several simplified views showing the heat sink member of the example of FIGS. 2A-C. FIG. 3A is an isometric view and FIGS. 3B-D are the three corresponding orthogonal views. In this example the spring member 110 is connected to the heat dissipation surface at the four corners of the enclosure. Optional features shown in these views include heat sink fins 202 as described above, circuit board connection points 302, mechanical interface 304 (e.g., for mounting on a tripod), and feedthrough 306 for power and data.

In the case of the example of FIG. 3A it has been calculated from analytical modeling and endurance test validation that the enclosure is able to dissipate 15 Watts of heat of a total of 15 Watts from the onboard processor to the heat dissipative surface of the acoustic camera without any significant heating of the air inside the enclosure. Under maximum performance conditions of the onboard processor the temperature delta between the processor temperature and the outer surface of the heat dissipater did not exceed 11 degrees Celsius, while reaching a steady state temperature after 16 hours. The processor core temperature remained well below its maximum rated values. In a direct comparison between the heat dissipation outer housing part as described above and a plastic outer housing variant containing the same onboard processor, the cores of the processor reached temperature limits within 3 minutes. Based on the power consumption maximum of the processor unit, the width and thickness of the outer housing area and of the internal heat sink member/heat spreader for heat dissipation can be determined and designed.

Additionally, the design of the heat sink member is preferably such that the complete design may be produced from a metal molding process. This enables large scale production and lower costs due to fewer assembly steps during production of the acoustic cameras. Furthermore, in the case of a larger processor unit with higher power dissipation, the cooling capacity of the assembly may be improved by disposing or inserting thermally conductive material into the mold.

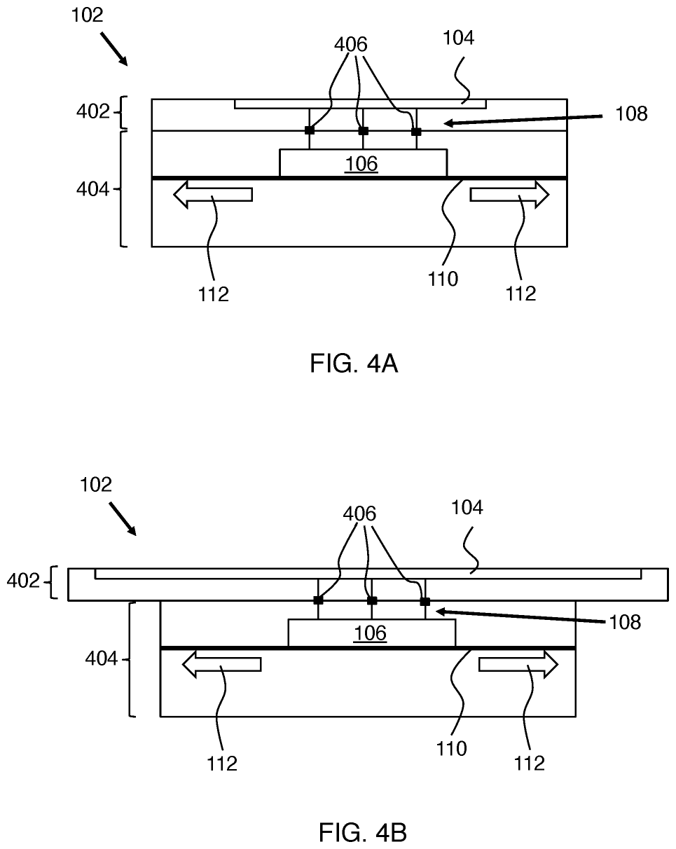

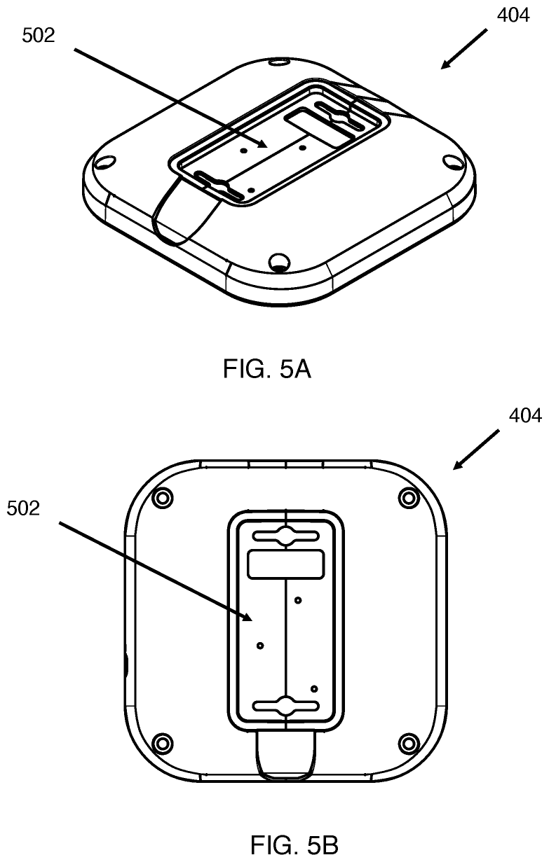

In the preceding examples, a single enclosure encloses both the onboard processor and the microphone array. In other embodiments, the enclosure has two parts—a first part including the acoustic microphone array and a second part including the onboard processor. FIG. 4A schematically shows a first example of this configuration. Here 402 is the first part of the enclosure 102 and 404 is the second part of the enclosure 102. Electrical connections 108 between the microphone array 104 and the onboard processor are made via contacts 406, which can be made with conventional electrical contact technology. Heat sinking of onboard processor 106 in this example is as described above.

One advantage provided by this configuration is the decoupling of the microphone array from the rest of the unit. This readily allows for configurations such as shown on FIG. 4B, where microphone array 104 has a greater lateral extent than the rest of the camera, and only first part 402 of the enclosure needs to be correspondingly enlarged. This decoupling has two advantages. A larger microphone array will tend to provide improved performance for low frequency sound, and keeping second part 404 at a smaller size should help with the heat sinking. Here it is believed that increasing the size of second part 404 of the enclosure would at least require additional thermal validation in detailed design, and may end up being objectively more difficult to design at the larger size if the resulting increased heat transfer path length is a problem.

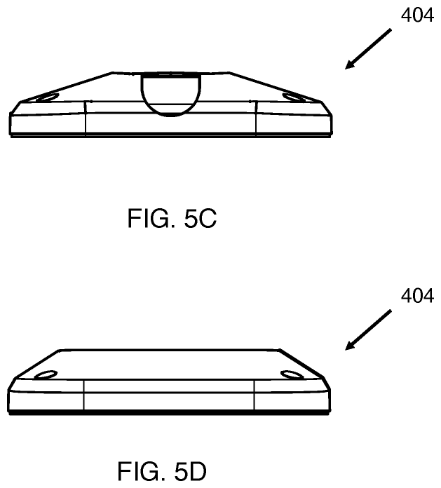

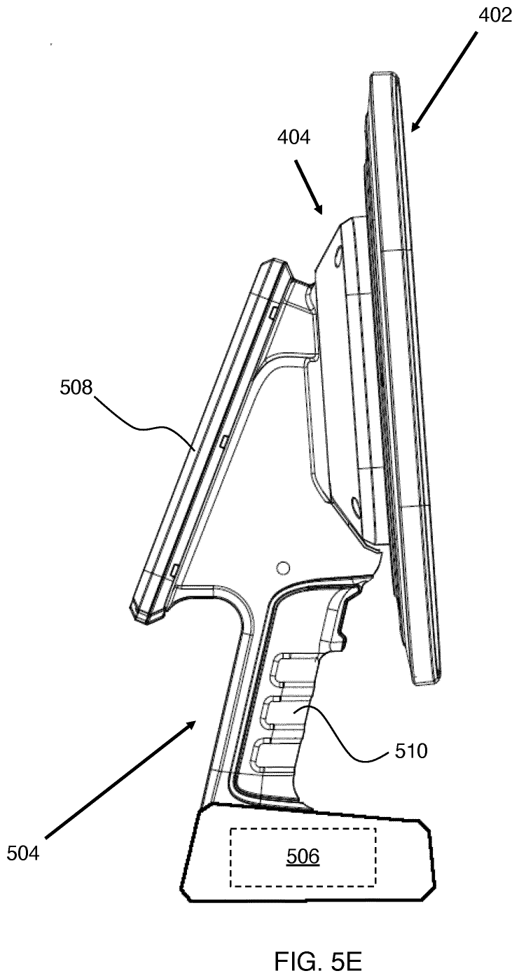

FIGS. 5A-D are several simplified views showing an exemplary second part 404. FIG. 5A is an isometric view and FIGS. 5B-D are the three corresponding orthogonal views. Here 502 is an interface for mating with the auxiliary unit described in connection with FIG. 5E.

FIG. 5E is a side view showing a hand-held acoustic camera having a two-part enclosure as on FIG. 4B, where the back side of the enclosure is attached to an auxiliary unit. Here 402 and 404 are the first and second parts, respectively, of the enclosure as described above. An auxiliary unit 504 is connected to the second part 404 of the enclosure.

The auxiliary unit 504 can include various components, such as: a pistol-grip 510 for handheld operation, a battery compartment 506 configured to provide electrical power to the onboard processor and to the acoustic microphone array, and a display 508 for providing a visual readout for the acoustic camera. Display 508 can be a touch screen display.

1. An acoustic camera comprising:
an enclosure configured to enclose a volume;
an acoustic microphone array disposed at a first surface of the enclosure and facing away from the volume;
an onboard processor disposed within the volume and electrically connected to the acoustic microphone array; and
a heat sink member in thermal contact with the onboard processor, wherein the heat sink member is configured to conduct heat from the onboard processor to a heat dissipation surface of the enclosure distinct from the first surface.

2. The acoustic camera of claim 1, further comprising one or more heat sink fins disposed on the heat dissipation surface.

3. The acoustic camera of claim 1, further comprising a spring member configured to provide a mechanical force tending to keep the heat sink member in thermal contact with the onboard processor.

4. The acoustic camera of claim 3, wherein the spring member is part of the heat sink member and is configured to make thermal contact to the onboard processor to conduct heat from the onboard processor to the heat dissipation surface.

5. The acoustic camera of claim 4, wherein the enclosure is square or rectangular and has four corners.

6. The acoustic camera of claim 5, wherein the spring member is connected to the heat dissipation surface at the four corners of the enclosure.

7. The acoustic camera of claim 3, further comprising a thermal transfer block configured to at least partially fill a space between the heat sink member and the onboard processor.

8. The acoustic camera of claim 1, wherein the enclosure includes a front plate, a back plate opposite to the front plate, and a side wall, wherein the side wall connects the front plate to the back plate to thereby enclose the volume.

9. The acoustic camera of claim 8, wherein the heat dissipation surface of the enclosure is on the side wall.

10. The acoustic camera of claim 1, wherein the enclosure has a first part including the acoustic microphone array and a second part including the onboard processor.

11. The acoustic camera of claim 10, further comprising an auxiliary unit connected to the second part of the enclosure.

12. The acoustic camera of claim 11, wherein the auxiliary unit includes one or more components selected from the group consisting of: a pistol-grip for handheld operation, a battery compartment configured to provide electrical power to the onboard processor and to the acoustic microphone array, and a display for providing a visual readout for the acoustic camera.

13. The acoustic camera of claim 12, wherein the display is a touch screen display.
